(19) United States
(12) Patent Application Publication
(10) Pub. No.: US 2019/0114904 A1
(43) Pub. Date: Apr. 18, 2019

(54) METHOD TO CONFIGURE, CONTROL AND MONITOR FIRE ALARM SYSTEMS USING VOICE COMMANDS

(71) Applicant: Carrier Corporation, Jupiter, FL (US)

(72) Inventor: Sabarigirinathan SUBRAMANIAN, Hyderabad (IN)

(21) Appl. No.: 15/840,576

(22) Filed: Dec. 13, 2017

(30) Foreign Application Priority Data
Oct. 16, 2017 (IN) 201711036662

(51) Int. Cl. G08B 29/12; G10L 15/22

(52) U.S. Cl. CPC G08B 29/12; G10L 2015/223; G10L 15/22

(57) ABSTRACT

A voice-based alarm system is provided. The voice-based alarm system includes alarm system devices which are respectively operable to detect various conditions within a predefined space and to take various actions relative to the various conditions within the predefined space. Each alarm system device is controllable by a portable computing device and information from each alarm system device is accessible to the portable computing device. The portable computing device is communicative with the alarm system devices and has a voice-based alarm system application stored thereon such that control of the alarm system devices and access to the information from each alarm system device is responsive to vocal commands entered into the voice-based alarm system application.

### CROSS-REFERENCE TO RELATED APPLICATIONS

This application claims the benefit of Indian Patent Application Number 201711036662 filed Oct. 16, 2017, which is incorporated herein by reference in its entirety.

### BACKGROUND

The following description relates to alarm systems and, more specifically, to a voice-based alarm system with multiple types of devices and alarms for use in a building.

A typical alarm system for a building, such as an office building or an apartment building, has multiple types of detectors and alarms. These include smoke, heat and carbon monoxide detectors as well as fire and smoke alarms. In addition, the typical alarm system has a control center including multiple panels that can be operated to show a status of the alarm system as well as multiple individuals who are required to install and support the alarm system. In an exemplary scenario, the individuals include a site engineer who generally installs the alarm system, an operator who mans the alarm system during day-to-day operations and a facility manager who is responsible for managing the site engineer and the operator and who makes decisions about when and how the alarm system should be managed. Each of the individuals thus requires a different type of access to the alarm system, usually by way of the multiple panels.

Typically, control panels require specific operator inputs to modify and control the system, and these inputs may require knowledge of specific syntax (e.g., for text-based configuration) and/or of the meaning and location of technical specifications (e.g., in an interactive interface-based configuration). Likewise, interpretation of alarm system outputs may require nuanced understanding of the alarm system's syntax. Further, the input and output functionality of an alarm system may be limited. For example, in an active alarm system there will often be quite a few alarms and identified issues (“events”) in a given period of time. These events may be centrally or distributively generated by the alarm system but the operator has to access a panel so that he can review the details of each event. This is often a time consuming process especially if there is an unusually large number of alarms or issues and the operator has to scroll through them on-by-one in the panel.

As another example, each device to be monitored by the system (e.g., First Floor_Smoke_BFC) must be initially identified within the system at system installation or modification, and each device location and function must be identified. Thus, during a typical commissioning process of fire alarms panels in the alarm system the device list for the panel has to be entered manually by the site engineer or the operator. This is also a time consuming process because there may be hundreds of devices each of which must be uniquely and specifically identified. In addition, during initial installation or modification testing such as fire alarm walk tests, or post-installation testing such as fire drills and regular testing and inspection of fire panels to check indicators and alarms it can be difficult for a given site engineer or operator to see test outputs for given devices especially when those outputs are only available for review at a remote panel. Finally, when a facility manager or operator wants to review a weekly report, they can usually only do so by way of a panel with particular software installed therein.

### BRIEF DESCRIPTION

According to an aspect of the disclosure, a voice-based alarm system is provided. The voice-based alarm system includes alarm system devices which are respectively operable to detect various conditions within a predefined space and to take various actions relative to the various conditions within the predefined space. Each alarm system device is controllable by a portable computing device and information from each alarm system device is accessible to the portable computing device. The portable computing device is communicative with the alarm system devices and has a voice-based alarm system application stored thereon such that control of the alarm system devices and access to the information from each alarm system device is responsive to vocal commands entered into the voice-based alarm system application.

In accordance with additional or alternative embodiments, a centralized communication system is provided by which the alarm system devices and the portable computing device are communicative.

In accordance with additional or alternative embodiments, control and information access panels are respectively associated with one or more of the alarm system devices.

In accordance with additional or alternative embodiments, the alarm system devices include smoke, fire and carbon monoxide detectors, heat detectors, pull alarms, manual call points, sounders, strobes and relay modules.

In accordance with additional or alternative embodiments, the alarm system devices are controllable in response to the vocal commands entered into the voice-based alarm system application to execute a configuration operation, to execute test runs and to respond to requests.

In accordance with additional or alternative embodiments, the portable computing device includes at least one of a smartphone, a tablet and a portable computer.

In accordance with additional or alternative embodiments, the voice-based alarm system application is configured in accordance with access-rights of a user.

In accordance with additional or alternative embodiments, the access-rights of the user include at least one or more of facility management access-rights, operations access-rights, security access-rights, commissioning access-rights, project engineering access-rights and site technician access-rights.

According to another aspect of the disclosure, a voice-based alarm system is provided for deployment in a building. The voice-based alarm system includes alarm system devices distributed throughout an interior of the building. The alarm system devices are respectively operable to detect various conditions within the building and to take various actions relative to the various conditions within the building. Each alarm system device is controllable by and information from each alarm system device is accessible to a user of a portable computing device. The portable computing device is communicative with the alarm system devices and has a voice-based alarm system application stored thereon such that user control of the alarm system devices and user access to the information from each alarm system device is responsive to vocal commands entered into the voice-based alarm system application by the user.

In accordance with additional or alternative embodiments, a centralized communication system is provided by which the alarm system devices and the portable computing device are communicative.

In accordance with additional or alternative embodiments, control and information access panels are respectively associated with one or more of the alarm system devices.

In accordance with additional or alternative embodiments, the alarm system devices include smoke, fire and carbon monoxide detectors, heat detectors, pull alarms, manual call points, sounders, strobes and relay modules.

In accordance with additional or alternative embodiments, the alarm system devices are controllable in response to the vocal commands entered into the voice-based alarm system application by the user to execute a configuration operation, to execute test runs and to respond to requests.

In accordance with additional or alternative embodiments, the portable computing device includes at least one of a smartphone, a tablet and a portable computer.

In accordance with additional or alternative embodiments, the voice-based alarm system application is configured in accordance with access-rights of the user.

In accordance with additional or alternative embodiments, the access-rights of the user include at least one or more of facility management access-rights, operations access-rights, security access-rights, commissioning access-rights, project engineering access-rights and site technician access-rights.

According to yet another aspect of the disclosure, a method of operating a voice-based alarm system is provided. The voice-based alarm system is deployed in a building in which alarm system devices are distributed to detect and to take various actions relative to various conditions within the building. The method includes installing a voice-based alarm system application on a portable computing device, registering a user with the voice-based alarm system to establish access-rights of the user through the voice-based alarm system application, receiving vocal commands entered into the voice-based alarm system application by the user, determining whether the vocal commands are consistent with the access-rights of the user and responding to the vocal commands by alarm system device control or with alarm system device information access in an event the vocal commands are determined to be consistent with the access-rights of the user.

In accordance with additional or alternative embodiments, the alarm system devices include smoke, fire and carbon monoxide detectors, heat detectors, pull alarms, manual call points, sounders, strobes and relay modules and the alarm system devices are controllable responsive to the vocal commands to execute a configuration operation, to execute test runs and to respond to requests.

In accordance with additional or alternative embodiments, the method further includes configuring the voice-based alarm system application in accordance with the access-rights of the user.

In accordance with additional or alternative embodiments, the access-rights of the user include at least one or more of facility management access-rights, operations access-rights, security access-rights, commissioning access-rights, project engineering access-rights and site technician access-rights.

These and other advantages and features will become more apparent from the following description taken in conjunction with the drawings.

### BRIEF DESCRIPTION OF THE DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a side view of a building in which a voice-based alarm system is deployed in accordance with embodiments;

FIG. 2 is a schematic diagram of a voice-based alarm system in accordance with embodiments;

FIG. 3 is a flow diagram illustrating an operation of the voice-based alarm system of FIG. 2 in accordance with embodiments;

FIG. 4 is a flow diagram illustrating an operation of the voice-based alarm system of FIG. 2 in accordance with embodiments;

FIG. 5 is a flow diagram illustrating an operation of the voice-based alarm system of FIG. 2 in accordance with embodiments; and

FIG. 6 is a flow diagram illustrating a method of operating a voice-based alarm system in accordance with embodiments.

These and other advantages and features will become more apparent from the following description taken in conjunction with the drawings.

### DETAILED DESCRIPTION

As will be described below, a voice-based alarm system is provided and improves situation response times and operator productivity to meet objectives of securing facilities and to reduce the engineering difficulty. During a commissioning phase, a site engineer using the voice-based alarm system will be able to call for a list of alarms vocally on a portable computing device on which a voice-based alarm system application is installed and will be able to review that list without having to go to various panels. In addition, the site engineer will also be able to use the voice-based alarm system application to configure many alarm system devices at once and without visiting each of those alarm system devices. Similarly, if an operator sets out to run alarm system device tests or if a facility manager wants to see a weekly report summarizing operations of the alarm system, the operator and the facility manager can do so with the voice-based alarm system application on their portable computing devices.

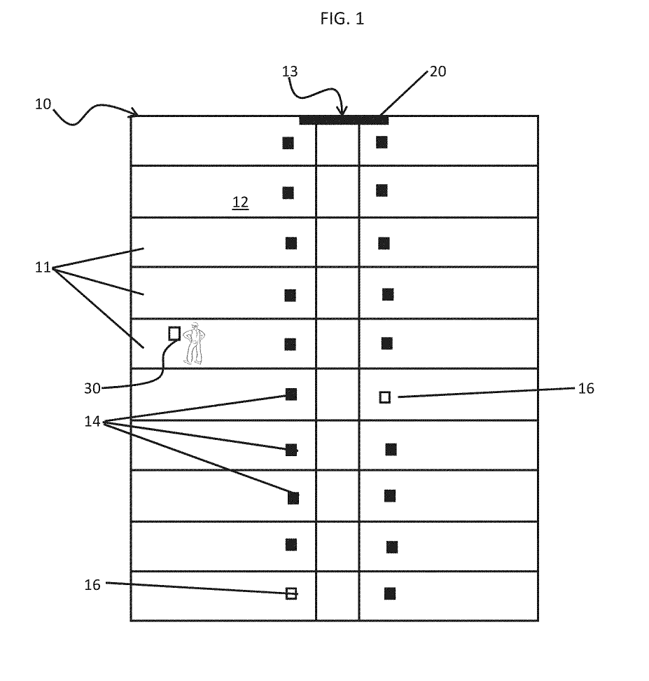

With reference to FIG. 1, a building 10 is provided and may include multiple floors 11 with multiple areas at each of the multiple floors 11 that together make up an interior 12 of the building 10. The building 10 further includes a voice-based alarm system 13. The voice-based alarm system 13 may include various alarm system devices 14 that are distributed throughout the interior 12 of the building 10 and, in some cases, may also include a centralized communication system 20 that may be local or remote with respect to the building 10. The alarm system devices 14 operate by detecting various conditions within the interior 12 of the building 10 and/or take various actions relative to those various conditions within the interior 12 of the building 10. To that end, the alarm system devices 14 may include, but are not limited to, smoke, fire and carbon monoxide detectors, heat detectors, pull alarms, manual call points, sounders, strobes and relay modules.

The voice-based alarm system 13 my further include control and/or information access panels 16. These control and/or information access panels 16 may be distributed throughout the interior 12 of the building 10 and are respectively associated with one or more of the alarm system devices 14. An authorized user, such as a site engineer, an operator or a facility manager of the building 10, can use the control and/or information access panels 16 to control various operations of the alarm system devices 14 and/or to obtain and access information relating to the alarm system devices 14.

In each case and for most but not necessarily all types of the alarm system devices 14, the alarm system devices 14 are installed in various areas of the interior 12 of the building 10. Upon installation, each device may be configured for a certain detection or action purpose, and may be tested to determine that they are functioning as configured and intended. Each device may also be configured to provide certain information upon request.

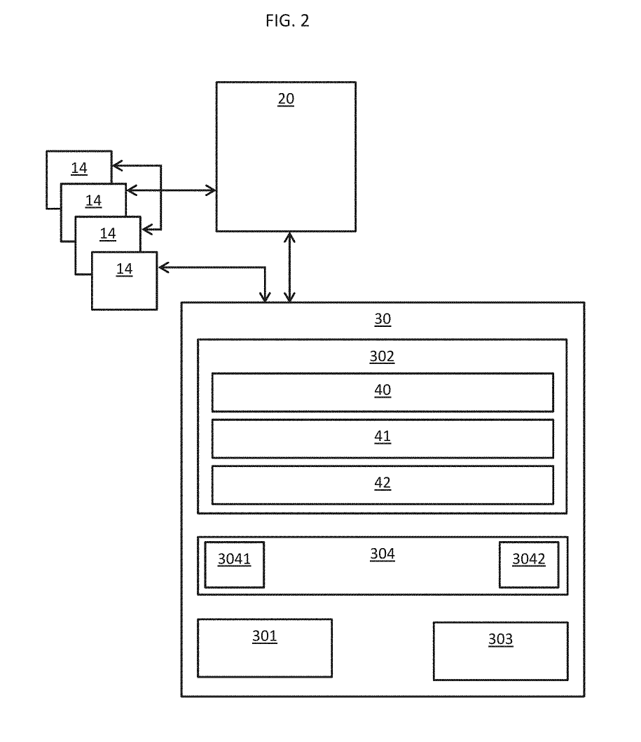

To this end, with reference to FIG. 2, the voice-based alarm system 13 may, but is not required to, include the centralized communication system 20 whereby the alarm system devices 14 are communicative with each other and with external computing devices. Also, each alarm system device 14 is controllable by at least one portable computing device 30. In addition, information from each alarm system device 14 is accessible to a user through portable computing device 30.

As shown in FIG. 2, the portable computing device 30 is communicative with the alarm system devices 14 either directly or via the centralized communication system 20. Portable computing device 30 has a voice-based alarm system application 40 stored thereon. A voice-based alarm system application 40 of the portable computing device 30 may be responsive to vocal commands of a user to enable user control of the alarm system devices 14 and user access to information from one or more alarm system devices 14 through an interface or such as a graphic display or speaker of portable computing device 30. More particularly, the alarm system devices 14 are controllable in response to the vocal commands entered into the voice-based alarm system application 40 of the portable computing device 30 by the user to execute at least one or more of a configuration operation, to execute test runs, to respond to requests and to do other similar setup, operational or quality control activities.

In accordance with embodiments, the centralized communication system 20 may include or be provided as one or more of a host computer, a server or a distributed plurality of routers and other communication devices whereas the portable computing device 30 may include or be provided as at least one of a smartphone, a tablet and a portable computer.

The portable computing device 30 may be provided within the voice-based alarm system 13 as multiple portable computing devices 30 that are each respectively associated with one or more users. Each of the portable computing devices 30 may include a processor 301, a memory unit 302, a networking unit 303 and at least one or more input/output unit (I/O) 304. The networking unit 303 provides for communications between the processor 301 and the alarm system devices 14 either directly or via the centralized communication system 20. The at least one or more input/output unit 304 may include a display device 3041, which may be configured to display information and a virtual keyboard to the user, and a microphone 3042 into which the user enters the vocal commands The memory unit 302 has the voice-based alarm system application 40, a language processing application 41 and executable instructions 42 stored thereon. The executable instructions 42 are executable by the processor 301 such that, when they are executed by the processor 301, they cause the processor 301 to execute or run the voice-based alarm system application 40, the language processing application 41 as well as other methods and algorithms as described herein.

During an initial setup of each portable computing device 30, the executable instructions 42 cause the processor 301 to install the voice-based alarm system application 40 on the memory unit 302 and to register the user with the voice-based alarm system 13. This registry serves to establish access-rights of the user through the voice-based alarm system application 40 in accordance with the user's job in the building or the user's position within an administration. For example, in various cases where the user is a site engineer, an operator or a facility manager, the users' access-rights will be consistent with those required by those jobs. Thus, the access-rights of the user may include at least one or more of facility management access-rights, operations access-rights, security access-rights, commissioning access-rights, project engineering access-rights and site technician access-rights.

Once the initial setup is complete, the executable instructions 42 and/or the voice-based alarm system application 40 may cause the processor 301 to configure (or reconfigure) the voice-based alarm system application 40 in accordance with the established access-rights of the user. Such configuring may, for example, activate certain voice commands as being legitimate or acceptable and deactivate others as being illegitimate or unacceptable, depending on the access rights granted to the user. That is, the vocal commands normally used by the site engineer may be activated for the user who is a site engineer but that user may not be permitted to use those vocal commands normally associated with the facility manager. The facility manager on the other hand may be permitted to use all of the vocal commands owing to his higher position in the administration hierarchy in the building 10. In some embodiments, one or more users may be granted access to all available functions, or in an alternative, to a customized subset of functions not pre-configured as a particular user type.

At this point, during operations of the voice-based alarm system 13, the executable instructions 42, the voice-based alarm system application 40 and/or the language processing application 41 may cause the processor 301 to receive vocal commands entered into the voice-based alarm system application 40 by the user via the I/O unit 304, to determine whether the vocal commands are consistent with the access-rights of the user and to respond to the vocal commands by alarm system device control or with alarm system device information access in an event the vocal commands are determined to be consistent with the access-rights of the user.

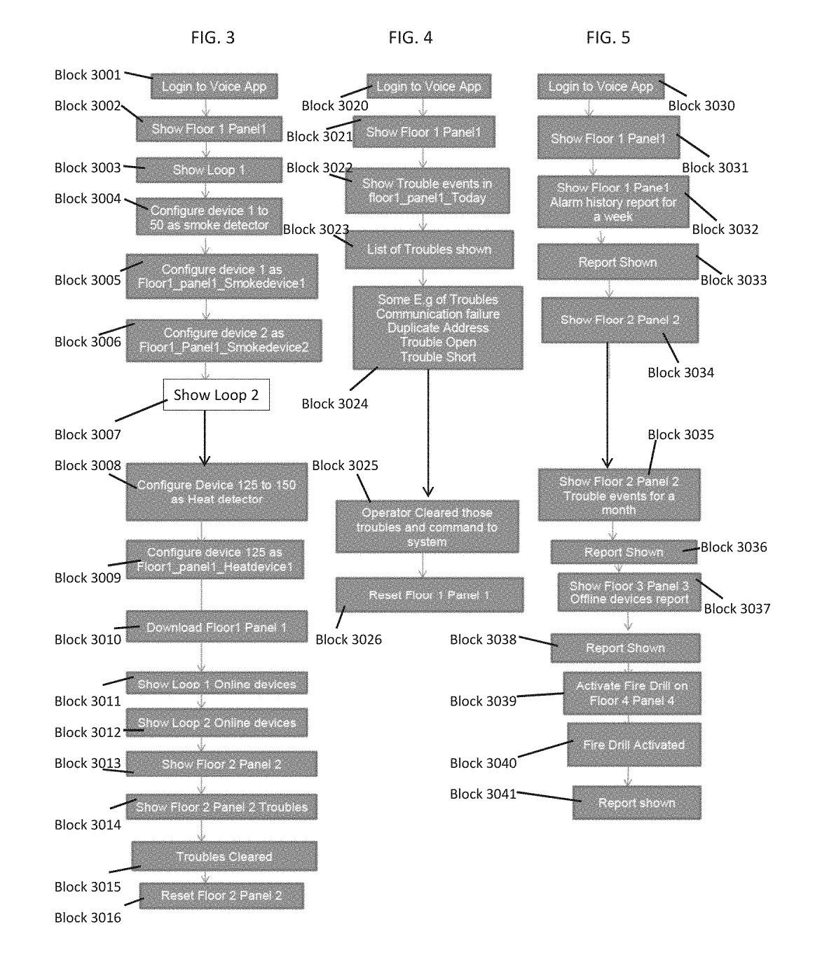

With reference to FIGS. 3-5, operational dialogues of various users and the voice-based alarm system will now be described and will illustrate the type of control the user will be able to exert over the alarm system devices 14 through vocal commands entered into the voice-based alarm system application 40 of his portable computing device 30 as well as the type of information relating the alarm system devices 14 that he will be able to access.

As shown in FIG. 3, where a user is a site engineer, the user may be responsible for configuring and testing voice-based alarm system 13, and may be granted access to commands available within voice-based alarm system application 40 to enable carrying out these tasks. As an exemplary example of configuring and testing the system 13, the user will login to the voice-based alarm system application 40 on his portable computing device 30 (block 3001) and may enter a command to display information related to one or more components of voice-based alarm system 13 such as various alarm system devices 14, or a named subset of alarm system devices 14; as shown in FIG. 3, the exemplary “show floor 1 panel 1” and “show loop 1” vocal commands (blocks 3002 and 3003) will prompt the voice-based alarm system application 40 to display on the screen of portable computing device 30 a layout and interconnections of certain alarm system devices 14. As exemplary configuration commands of voice-based alarm system application 40 the user may enter the “configure device 1 to 50 as smoke detector”, the “configure device 1 as floorl panel 1 smoke device 1” and the “configure device 2 as floor 1 panel 1 smoke device 2” vocal commands to configure devices 1 and 2 as smoke detectors (blocks 3004-3006).

As a further example, the user may configure separate subsets of components, for example, the user may enter the “show loop 2” vocal command to prompt the voice-based alarm system application 40 to display on a graphical interface of portable computing device 30 a layout of other alarm system devices 14 (block 3007). The user may enter configuration comments vocally, such as the “configure device 125 to 150 as heat detector” and the “configure device 125 as floorl panel 1 heat device 1” vocal commands to configure devices 125 to 150 (blocks 3008 and 3009). The user may also be able to specify more specific actions, such as enter the “download floor 1 panel 1” in order to retrieve or otherwise access information from the corresponding floor panel (block 3010). The user may also be able to issue voice commands prompting the voice-based alarm system application 40 to specify more specific actions or display more targeted information, such as the “show loop 1 online devices”, the show loop 2 online devices“, the “show floor 2 panel 2” and the “shown floor 2 panel 2 troubles” to review further information of still other alarm system devices 14 (blocks 3011-3014). Finally, the user will be able to enter the “troubles cleared” and the “reset floor 2 panel 2” vocal commands to complete his tasks and to set a reset condition (blocks 3015 and 3016).

As shown in FIG. 4, where a user is an operator, the user may be responsible for monitoring the status of components of voice-based alarm system 13, and responding to events generated by the system, and may be granted access to commands available within voice-based alarm system application 40 to enable carrying out these tasks. As an exemplary example of monitoring and responding to the system, the user will login to the voice-based alarm system application 40 on his portable computing device 30 (block 3020) and may enter a command to display information related to one or more components or events of voice-based alarm system 13 such as those regarding various alarm system devices 14, or a named subset of alarm system devices 14; as shown in FIG. 4, the exemplary “show floor 1 panel 1” and “show trouble events in floor 1 panel 1 today” vocal commands (blocks 3021 and 3022) will prompt the voice-based alarm system application 40 to display on the screen of portable computing device 30 a layout and interconnections of certain alarm system devices 14 and a list of issues with those alarm system devices 14. The alarm system devices 14 will then report their corresponding information to the portable computing device 30 for display to the user directly via wireless communication, or via the centralized communication system 20 (blocks 3023 and 3024). The user may then issue a voice command prompting voice-based alarm system application 40 to clear those events from the voice-based alarm system 13, and reset one or more control and/or information access panels 16 (block 3025 and 3026).

As shown in FIG. 5, where a user is a facility manager, operator, the user may be responsible for monitoring the status of components of voice-based alarm system 13 over a period of time, and for testing voice-based alarm system 13, and may be granted access to commands available within voice-based alarm system application 40 to enable carrying out these tasks. As an exemplary example of monitoring and testing the system 13, the user will login to the voice-based alarm system application 40 on his portable computing device 30 (block 3030) and may enter a command to display information related to one or more components of voice-based alarm system 13 such as various alarm system devices 14, or a named subset of alarm system devices 14, and may specify a time period for the amount of information that should be reported, and/or may specify an event type; as shown in FIG. 5, the exemplary “show floor 1 panel 1” and “show floor 1 panel 1 alarm history report for a week” vocal commands (blocks 3031 and 3032) will prompt the voice-based alarm system application 40 to display on the screen of portable computing device 30 a layout and interconnections of certain alarm system devices 14 and a performance summary of the voice-based alarm system 13 for the preceding week. The voice-based alarm system 13 will then cooperatively provide the requested information to the user (block 3033).

In another example, the user may request different types of information allowed by their access types and as provided by the voice-based alarm system application 40, for example the user may enter the “show floor 2 panel 2” and the “show floor 2 panel 2 trouble events for a month” vocal commands (blocks 3034 and 3035) which may prompt the voice-based alarm system application 40 to display on the screen of portable computing device 30 a layout and interconnections of certain alarm system devices 14 and a performance summary of the voice-based alarm system 13 for the preceding month. The voice-based alarm system 13 will then cooperatively provide the requested information to the user (block 3036).

In a further example, the user may enter the “show floor 3 panel 3” and the “show floor 3 panel 3 offline devices report” vocal commands (blocks 3037 and 3038) which may prompt the voice-based alarm system application 40 to display on the screen of portable computing device 30 a layout and interconnections of certain alarm system devices 14 and a performance summary of offline devices of the voice-based alarm system 13. The voice-based alarm system 13 will then cooperatively provide the requested information to the user (block 3039). Lastly, the user may prompt voice-based alarm system 13 to execute a testing routine; for example, via voice-based alarm system application 40 the user may enter the “activate fire drill on floor 4 panel 4” vocal command (block 3040) so that the corresponding alarm routine may be run and subsequent report shown (blocks 3041 and 3042).

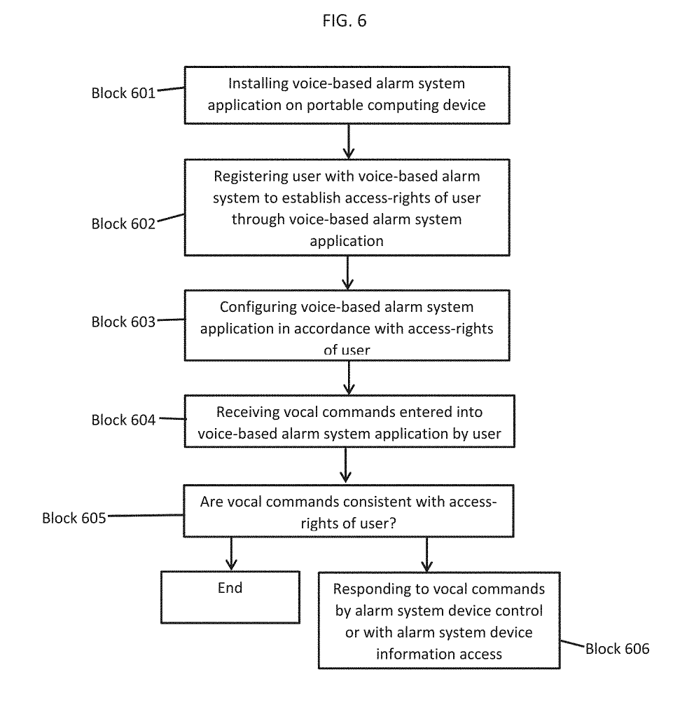

With reference to FIG. 6, a method of operating a voice-based alarm system, as described above, is provided for deployment in a building in which alarm system devices 14 are distributed to detect and to take various actions relative to various conditions within the building. As shown in FIG. 6, the method includes installing a voice-based alarm system application on a portable computing device (block 601), registering a user with the voice-based alarm system to establish access-rights of the user through the voice-based alarm system application (block 602) and configuring the voice-based alarm system application in accordance with the access-rights of the user (block 603). The method further includes receiving vocal commands entered into the voice-based alarm system application by the user (block 604), determining whether the vocal commands are consistent with the access-rights of the user (block 605) and responding to the vocal commands by alarm system device control or with alarm system device information access in an event the vocal commands are determined to be consistent with the access-rights of the user (block 606).

In accordance with additional embodiments, a central processing unit (CPU) board, a power supply module and loop cards (with a possible maximum of ten loop cards) can be connected to the control panel and may need to be configured manually. Such manual configurations can be completed by an operator, such as a site engineer, through the voice-based alarm system application 40. Similarly, the voice-based alarm system application 40 can be used for access control systems applications where site engineers have to configure many access control features (e.g., hundreds of door controllers and readers) and they have to create various access profiles and where facility managers have to be able to see various type of reports like door history reports and reports about certain doors being open for too long).

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A voice-based alarm system, comprising:
alarm system devices which are respectively operable to detect various conditions within a predefined space and to take various actions relative to the various conditions within the predefined space,
each alarm system device being controllable by a portable computing device and information from each alarm system device being accessible to the portable computing device,
the portable computing device being communicative with the alarm system devices and having a voice-based alarm system application stored thereon such that control of the alarm system devices and access to the information from each alarm system device is responsive to vocal commands entered into the voice-based alarm system application.

2. The voice-based alarm system according to claim 1, further comprising a centralized communication system by which the alarm system devices and the portable computing device are communicative.

3. The voice-based alarm system according to claim 1, further comprising control and information access panels respectively associated with one or more of the alarm system devices.

4. The voice-based alarm system according to claim 1, wherein the alarm system devices comprise smoke, fire and carbon monoxide detectors, heat detectors, pull alarms, manual call points, sounders, strobes and relay modules.

5. The voice-based alarm system according to claim 1, wherein the alarm system devices are controllable in response to the vocal commands entered into the voice-based alarm system application to execute a configuration operation, to execute test runs and to respond to requests.

6. The voice-based alarm system according to claim 1, wherein the portable computing device comprises at least one of a smartphone, a tablet and a portable computer.

7. The voice-based alarm system according to claim 1, wherein the voice-based alarm system application is configured in accordance with access-rights of a user.

8. The voice-based alarm system according to claim 7, wherein the access-rights of the user comprise at least one or more of facility management access-rights, operations access-rights, security access-rights, commissioning access-rights, project engineering access-rights and site technician access-rights.

9. A voice-based alarm system for deployment in a building, the voice-based alarm system comprising:
alarm system devices distributed throughout an interior of the building,
the alarm system devices being respectively operable to detect various conditions within the building and to take various actions relative to the various conditions within the building,
each alarm system device being controllable by and information from each alarm system device being accessible to a user of a portable computing device,
the portable computing device being communicative with the alarm system devices and having a voice-based alarm system application stored thereon such that user control of the alarm system devices and user access to the information from each alarm system device is responsive to vocal commands entered into the voice-based alarm system application by the user.

10. The voice-based alarm system according to claim 9, further comprising a centralized communication system by which the alarm system devices and the portable computing device are communicative.

11. The voice-based alarm system according to claim 9, further comprising control and information access panels respectively associated with one or more of the alarm system devices.

12. The voice-based alarm system according to claim 9, wherein the alarm system devices comprise smoke, fire and carbon monoxide detectors, heat detectors, pull alarms, manual call points, sounders, strobes and relay modules.

13. The voice-based alarm system according to claim 9, wherein the alarm system devices are controllable in response to the vocal commands entered into the voice-based alarm system application by the user to execute a configuration operation, to execute test runs and to respond to requests.

14. The voice-based alarm system according to claim 9 wherein the portable computing device comprises at least one of a smartphone, a tablet and a portable computer.

15. The voice-based alarm system according to claim 9, wherein the voice-based alarm system application is configured in accordance with access-rights of the user.

16. The voice-based alarm system according to claim 15, wherein the access-rights of the user comprise at least one or more of facility management access-rights, operations access-rights, security access-rights, commissioning access-rights, project engineering access-rights and site technician access-rights.

17. A method of operating a voice-based alarm system deployed in a building in which alarm system devices are distributed to detect and to take various actions relative to various conditions within the building, the method comprising:
installing a voice-based alarm system application on a portable computing device;
registering a user with the voice-based alarm system to establish access-rights of the user through the voice-based alarm system application;
receiving vocal commands entered into the voice-based alarm system application by the user;
determining whether the vocal commands are consistent with the access-rights of the user; and
responding to the vocal commands by alarm system device control or with alarm system device information access in an event the vocal commands are determined to be consistent with the access-rights of the user.

18. The method according to claim 17, wherein:
the alarm system devices comprise smoke, fire and carbon monoxide detectors, heat detectors, pull alarms, manual call points, sounders, strobes and relay modules, and
the alarm system devices are controllable responsive to the vocal commands to execute a configuration operation, to execute test runs and to respond to requests.

19. The method according to claim 17, further comprising configuring the voice-based alarm system application in accordance with the access-rights of the user.

20. The method according to claim 19, wherein the access-rights of the user comprise at least one or more of facility management access-rights, operations access-rights, security access-rights, commissioning access-rights, project engineering access-rights and site technician access-rights.
